(19) United States
(12) Patent Application Publication
(10) Pub. No.: US 2012/0038619 A1
(43) Pub. Date: Feb. 16, 2012

(54) SYSTEM AND METHOD FOR CONTROLLING INDUCTIVE POWER TO MULTIPLE MODULES

(75) Inventors: Rotem Shraga, Beer Sheva (IL); Amir Ben-Shalom, Modiin (IL); Yoel Raab, Hod Hasharon (IL)

(73) Assignee: POWERMAT LTD., Neve Ilan (IL)

(21) Appl. No.: 13/228,991

(22) Filed: Sep. 9, 2011

Related U.S. Application Data
(63) Continuation-in-part of application No. PCT/IL2010/000209, filed on Mar. 11, 2010.
Application No. PCT/IL2010/000209 is a continuation-in-part of application No. 12/563,544, filed on Sep. 21, 2009.
Application No. 12/563,544 is a continuation of application No. PCT/IL2008/000401, filed on Mar. 23, 2008.
(60) Provisional application No. 61/202,554, filed on Mar. 12, 2009.
(60) Provisional application No. 61/202,555, filed on Mar. 12, 2009.
(60) Provisional application No. 61/202,567, filed on Mar. 12, 2009.
(60) Provisional application No. 60/907,132, filed on Mar. 22, 2007.
(60) Provisional application No. 60/935,847, filed on Sep. 4, 2007.
(60) Provisional application No. 61/006,076, filed on Dec. 18, 2007.
(60) Provisional application No. 61/006,106, filed on Dec. 19, 2007.
(60) Provisional application No. 61/006,488, filed on Jan. 16, 2008.
(60) Provisional application No. 61/006,721, filed on Jan. 29, 2008.

(51) Int. Cl. G09G 5/00

(52) U.S. Cl. 345/212; 345/1.3; 345/204

(57) ABSTRACT

A system and method for controlling power distribution from a plurality of inductive power outlets to a plurality of inductive power receivers include inductive outlets and receivers that are provided with a signal transfer system for communicating unique identification labels. Applications are described relating to the control of modular visual displays and interchangeably situated electrical devices.

### CROSS-REFERENCE TO RELATED APPLICATIONS

This application is a continuation of PCT/IL2010/000209 filed Mar. 11, 2010, which claims the benefit of U.S. provisional application Ser. Nos. 61/202,554 filed Mar. 12, 2009; 61/202,555 filed Mar. 12, 2009; and 61/202,567 filed Mar. 12, 2009, and a continuation-in-part of U.S. Ser. No. 12/563,544 filed Sep. 21, 2009, which is a continuation of PCT application Serial No. PCT/IL2008/000401 filed Mar. 23, 2008, which claims the benefit of U.S. provisional application Ser. Nos. 60/907,132 filed Mar. 22, 2007, 60/935,847 filed Sep. 4, 2007, 61/006,076 filed Dec. 18, 2007, 61/006,106 filed Dec. 19, 2007, 61/006,488 filed Jan. 16, 2008 and 61/006,721 filed Jan. 29, 2008

### TECHNICAL FIELD

The present disclosure relates to methods and systems for controlling inductive power distribution to interchangeable electrical devices and controlling electrical devices such as display modules for displaying extended visual presentations over a surface.

### BACKGROUND

Power may be transferred from inductive power outlets to inductive power receivers by electromagnetic induction. An inductive power outlet typically includes a primary inductor connected to a power source via a driver and an inductive power receiver typically includes a secondary inductor which may be connected to an electric load. Power may be transferred to the electric load by the driver applying an oscillating voltage across the primary inductor, which generates an associated variable magnetic field. When the secondary inductor is placed in the vicinity of the primary inductor's variable magnetic field an electric potential is induced thereacross.

Inductive power transfer systems are useful for providing versatile power distribution. Electrical devices connected to inductive power receivers may be moved from outlet to outlet without the need for connecting wires. However, their moving may lead to problems when controlling the power distribution. Whereas, in a hardwired system, electrical devices may be readily controlled centrally, it is not easy to centrally control electrical devices which are not tied to a single power outlet.

For example, a typical hardwired lighting circuit for a room may include a number of separate lamps each of which is controlled by a dedicated switch in a central switch board. In an inductive power distribution system, these lamps may be interchangeable so it is impractical to use a central controller wired to the outlets alone to control specific lamps.

It is further noted that large visual displays, used for example in roadside advertisements, are not typically dynamic. In general slogan bearing, static posters are simply pasted onto billboards situated at road sides near junctions and in other areas of high visibility. To alter such displays, such as to change the contents thereof, a different poster needs to be pasted up. Such billboards generally display the same advertisement for a few days or weeks at a time.

Electronic visual display units (VDUs), such as television sets and computer monitors for example, receive information as electrical signals and convert them for display as visual images on a screen. Many such display units consist of pixels, which are discrete optical elements. In Liquid Crystal Displays the optical states of these elements change in response to an electrical voltage applied thereacross. The optical characteristics, such as the polarization thereof, scattering angle and reflectivity of each pixel depend upon these optical states. By providing voltage selectively to each pixel of the display, a visual image may be constructed and displayed.

Although VDUs may be used for displaying actively changing advertisements, such advertising displays are generally smaller than billboards, have high installation and running costs.

There is therefore a need for an effective central control system for controlling power distribution to interchangeable electrical devices and which may be applicable to adjustable visual display systems. Further embodiments described herein address this need.

### SUMMARY

Power may be transferred from inductive power outlets to inductive power receivers by electromagnetic induction. An inductive power outlet typically includes a primary inductor connected to a power source via a driver and an inductive power receiver typically includes a secondary inductor which may be connected to an electric load. Power may be transferred to the electric load by the driver applying an oscillating voltage across the primary inductor, which generates an associated variable magnetic field. When the secondary inductor is placed in the vicinity of the primary inductor's variable magnetic field an electric potential is induced thereacross.

Inductive power transfer systems are useful for providing versatile power distribution. Electrical devices connected to inductive power receivers may be moved from outlet to outlet without the need for connecting wires. However, their moving may lead to problems when controlling the power distribution. Whereas, in a hardwired system, electrical devices may be readily controlled centrally, it is not easy to centrally control electrical devices which are not tied to a single power outlet.

For example, a typical hardwired lighting circuit for a room may include a number of separate lamps each of which is controlled by a dedicated switch in a central switch board. In an inductive power distribution system, these lamps may be interchangeable so it is impractical to use a central controller wired to the outlets alone to control specific lamps.

It is further noted that large visual displays, used for example in roadside advertisements, are not typically dynamic. In general slogan bearing, static posters are simply pasted onto billboards situated at road sides near junctions and in other areas of high visibility. To alter such displays, such as to change the contents thereof, a different poster needs to be pasted up. Such billboards generally display the same advertisement for a few days or weeks at a time.

Electronic visual display units (VDUs), such as television sets and computer monitors for example, receive information as electrical signals and convert them for display as visual images on a screen. Many such display units consist of pixels, which are discrete optical elements. In Liquid Crystal Displays the optical states of these elements change in response to an electrical voltage applied thereacross. The optical characteristics, such as the polarization thereof, scattering angle and reflectivity of each pixel depend upon these optical states. By providing voltage selectively to each pixel of the display, a visual image may be constructed and displayed.

Although VDUs may be used for displaying actively changing advertisements, such advertising displays are generally smaller than billboards, have high installation and running costs.

There is therefore a need for an effective central control system for controlling power distribution to interchangeable electrical devices and which may be applicable to adjustable visual display systems. Further embodiments described herein address this need.

### BRIEF DESCRIPTION OF THE DRAWINGS

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a block diagram representing the main components of a mated inductive pair according to one embodiment;

FIG. 2a is a schematic representation of a display system with interchangeable panels including inductive receivers configured to mate with inductive outlets according to another embodiment;

FIG. 2b shows an exploded schematic view of an interchangeable panel of the display system of FIG. 2a;

FIG. 3 is a schematic representation of an inductive power transfer system incorporated into a surface with a central control panel for controlling power provision to a variety of electrical devices, according to a further embodiment;

FIG. 4a is a flowchart of a method for mating an inductive power outlet and an inductive power receiver according to another embodiment;

FIG. 4b is a flowchart of a method for controlling power distribution in an inductive power distribution system according to still another embodiment;

FIG. 5a is a schematic exploded view of an embodiment of a display system constructed from a plurality of panels;

FIG. 5b is a block diagram showing the main elements of the display system according to another embodiment;

FIG. 5c is a block diagram showing the components of the visual display of the display panel incorporating a plurality of optically active pixels according to another embodiment;

FIG. 6 is a flowchart representing a method for providing an adjustable visual display according to still another embodiment;

FIG. 7a is a schematic representation of the main components of a system for remotely controlling a modular display from computer terminal connected to the internet according to another embodiment of the display system;

FIG. 7b, is a schematic representation of a dot matrix which may be used to construct characters and images in the visual display according to various embodiments;

FIG. 8a is a block diagram of the main components of a display-master for use with embodiments of the display system;

FIG. 8b is a block diagram representing the main components of a display module for use with embodiments, and

FIG. 9 is a flowchart of a method for remotely controlling a display system according to another embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

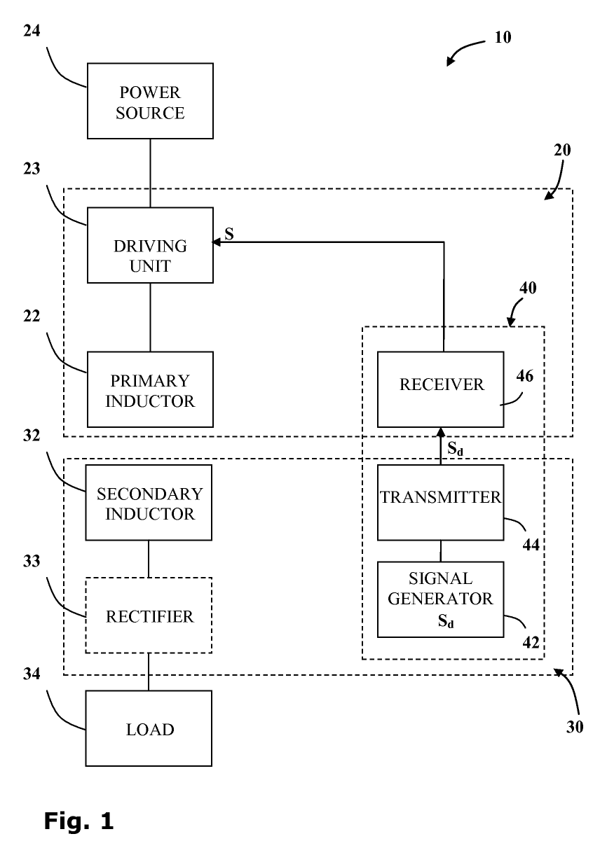

Reference is now made to FIG. 1 showing a block diagram of the main components of a mated inductive pair 10 according to one embodiment of the current invention. The inductive pair 10 consists of an inductive power outlet 20 and an inductive power receiver 30.

The inductive power outlet 20 consists of a primary inductor 22, such as a coil of wire or the like, wired to a power source 24 via a driving unit 23. The driving unit 23 provides the electronics necessary for driving the primary inductor 22. Driving electronics may include for example a switching unit for providing a high frequency oscillating potential across the primary inductor 22.

The inductive power receiver 30 comprises a secondary inductor 32. The inductive power receiver 30 comprises a secondary inductor 32 which may be coupled to an electric load 34 optionally via a rectifier 33 for converting the alternating current output of the secondary inductor 32 into a direct current supply to the load 34.

It is a particular feature of embodiments of the present invention that the inductive pair 10 further consists of a signal transfer system 40. The signal transfer system 40 includes a signal generator 42, a transmitter 44 and a detector 46.

The signal generator 42 generates a data signal Sd which is sent to the transmitter 44 for transmitting to the detector 46. It will be appreciated that the transmitter 44 may be associated with either the power outlet 20 or the power receiver 30 as required. Thus communication of the data signal Sd may be provided either from the power outlet 20 to the power receiver 30 or from the power receiver 30 to the power outlet 20. Indeed, where appropriate, bidirectional communication pathways may be provided.

Preferably, the power receiver 30 and power outlet 20 are both labeled with unique identifiers. The signal transfer system 40 may be used to communicate an identification label between the inductive power outlet 20 and the inductive power receiver 30. Thus the inductive pair may be mated together by communicating the identity of the power receiver 30 to its associated power outlet 20 and/or communicating the identity of the power outlet 20 to the power receiver 30.

Various embodiments of the invention use various transmitter-detector interfaces. For example an optical transmitter such as a lamp, a light emitting diode or the like, may be used to interface with an optical detector, such as a light dependent resistor, a light dependent transistor or the like. Alternative arrangements may use radio transmitter-receiver interfaces, audio transmitter-receiver interfaces, ultrasonic transducers-piezoelectric detector interfaces, optocouplers, coil-to-coil data transfer systems or such like.

In a particular preferred embodiment of the invention, the driving unit 23 applies a driving voltage across the primary inductor 22, which oscillates at a transmission frequency higher than the resonant frequency of the system. A reception circuit is usefully wired to the primary inductor 22. The reception circuit typically comprises a voltage monitor for monitoring the amplitude of the voltage across the primary coil.

A transmission circuit is likewise wired to the secondary inductor for sending a data signal to the reception circuit. In a specific embodiment of the transmission circuit, the signal generator is configured to generate the data signal by intermittently connecting at least one electric element to the secondary inductor 32 thereby increasing the resonant frequency. Each increase in the resonant frequency of the system may be detected by the reception circuit as a spike in the voltage monitored by the voltage monitor. Other signal transmission systems 40 may be preferred for use in other embodiments of the present invention as appropriate.

### Interchangeable Display Panels

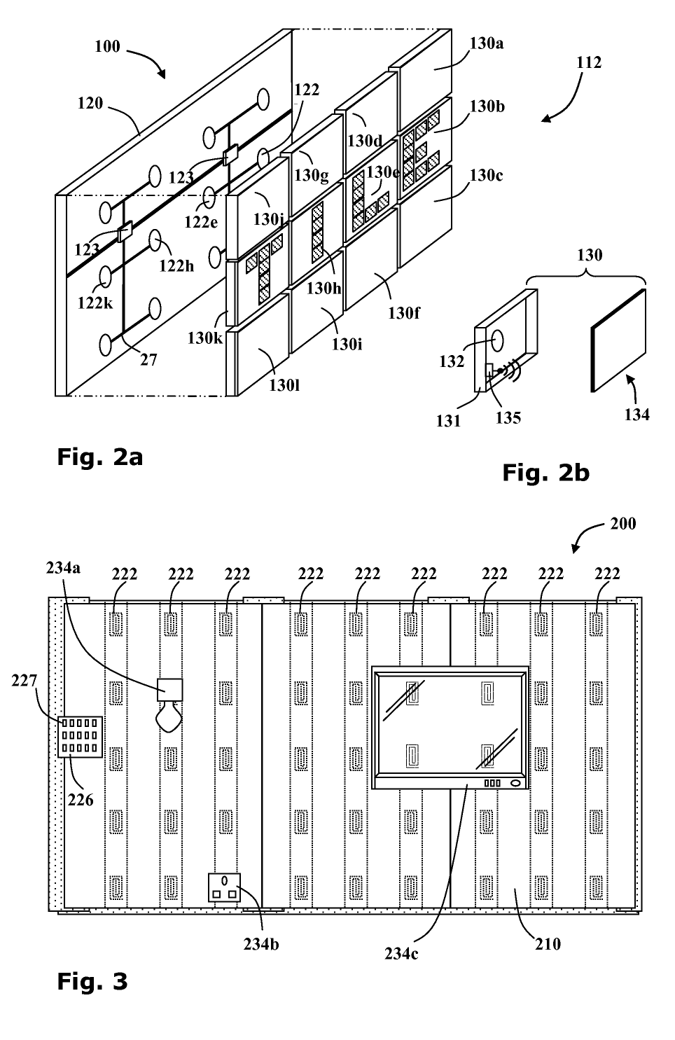

According to other embodiments of the invention, the mated inductive couple may be used in a power distribution system for providing power to a plurality of different electrical devices. Referring now to FIGS. 2a and 2b, one embodiment of a power distribution system 100 is presented. The system 100 provides a surface 112 having adjustable visual properties such that an image may be presented across multiple display panels 130. The display panels 130 are interchangeable units 131, having a visual output surface 134 wired to an inductive power receiver 132. The panels 130 are adapted to be connected to the support structure 20 by some fastening means such as hooks, screws, pins, adhesives, magnets or the like. It is noted that in various embodiments of the invention, the system 100 may be used to provide, inter alia, adjustable decors for a room, interactive signs, electronic advertising billboards, stage scenery and the like.

A support structure 120, such as a wall or a floor of a room for example, includes an array of inductive power outlets 122 connected to a power source via driving units 123. Optionally, a plurality of inductive power outlets 122 are connected to common driving unit 123. In a particular embodiment, suitable wire 125 is used to supply power to the driving unit, for providing a universal A.C. voltage between 90V and 240V, whereas 3 A conductors 127 may be suitable for distributing power to the power outlets 122. In other embodiments alternative conductors may be selected as appropriate.

In certain embodiments of the display system 100 the display panels 130 further comprise individual receivers 135 configured to receive remote signals indicating the desired display for their associated panel. Thus, for example, a row of four panels 130k, 130h, 130e, 130b may each receive a separate signal indicating that they each display a letter T, I, L and E say, spelling the word TILE.

It is particularly noted that display panels 130 are essentially identical to each other and are thus readily interchangeable. In order that a desired image, the word TILE, say, is retained when two panels are interchanged, it is useful to mate the power receivers 132 hosted by the panels with the power outlets 122 on the support structure. Thus if the L-panel 130e, mated to a first power outlet 122e, were to be swapped with the T-panel 130k, mated to a second power outlet 122k, the power receiver 132 of the L-panel 130e would mate with the second power outlet 122k and the power receiver 132 of the T-panel 130k would mate with the first power outlet 122e. As a result of its new location, the L-panel 130e would update its display to show a letter T and the T panel 130k would update its display to show a letter E. Thus the word TILE would remain unchanged.

### Interchangeable Electrical Devices

According to other embodiments, interchangeable electrical devices may be associated with each power receiver. FIG. 3 shows a power distribution system 200 consisting of an array of inductive power outlets 222 incorporated within a wall 210. Interchangeable electrical devices 234, such as a light fixture 234a, a conductive power outlet socket 234b and a television 234c, for example, are wired to inductive power receivers (not shown).

A central controller 226 is provided for switching power to the individual devices 234. By mating the power receivers to specific power outlets 222, a dedicated control switch 227 may be used to control a particular device 234. A power receiver may send an identification code to a mated power outlet 222 associating it with a specific electrical device 234. Consequently, when the dedicated control switch 227 sends a signal for controlling the specific electrical device 234, say the light fixture 234a, only the power outlet 222 mated with the light fixture 234a, responds to the signal for example by activating or deactivating the primary inductor. Thus the light fixture 234a may be moved to another location and mated to another power outlet 222, according to requirements yet the light fixture 234a may still be controlled centrally by the same dedicated power switch 227.

In still further embodiments of the invention, a power distribution system involving mated inductive power outlets may be useful for example for wirelessly providing power to a plurality of stage lights controlled centrally by a lighting console. In another application, power may be provided to a plurality of microphones, amplifiers and the like inductively, avoiding the need for dangerous and unsightly trailing wires across a stage. By mating each inductive receiver to its current inductive outlet each unit may be controlled centrally whilst providing maximum mobility during a concert. Other applications of the invention will occur to those skilled in the art.

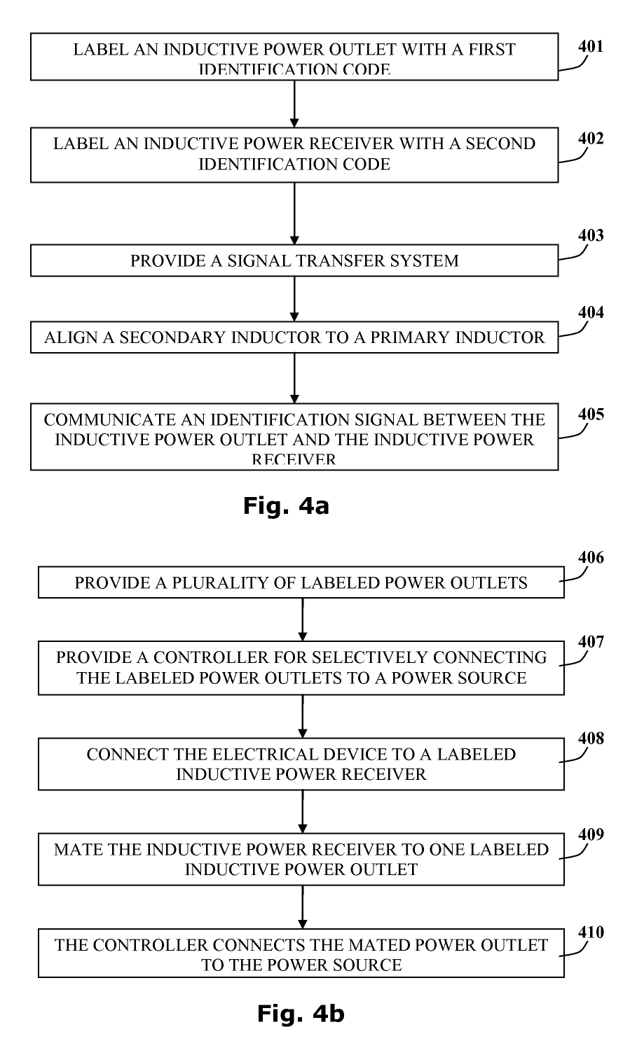

With reference to FIG. 4a a flowchart is shown representing a method for mating an inductive power outlet with an inductive power receiver. The method comprises the following steps: labeling an inductive power outlet with a first identification code 401, labeling an inductive power receiver with a second identification code 402, providing a signal transfer system 403, aligning a secondary inductor to a primary inductor 404 and communicating an identification signal between the inductive power outlet and the inductive power receiver 405.

Referring to FIG. 4b, a flowchart of a further method for controlling power distribution to specific electric devices is presented. The method comprises the steps of: providing a plurality of labeled power outlets 406, providing a controller for selectively connecting the labeled power outlets to a power source 407, connecting the electrical device to a labeled inductive power receiver 408, mating the inductive power receiver to one labeled inductive power outlet 409 and the controller connecting the mated power outlet to the power source 410.

### Modular Display Systems

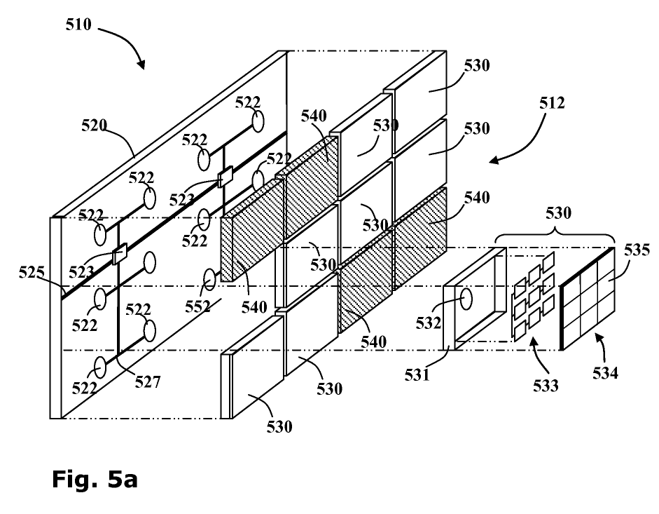

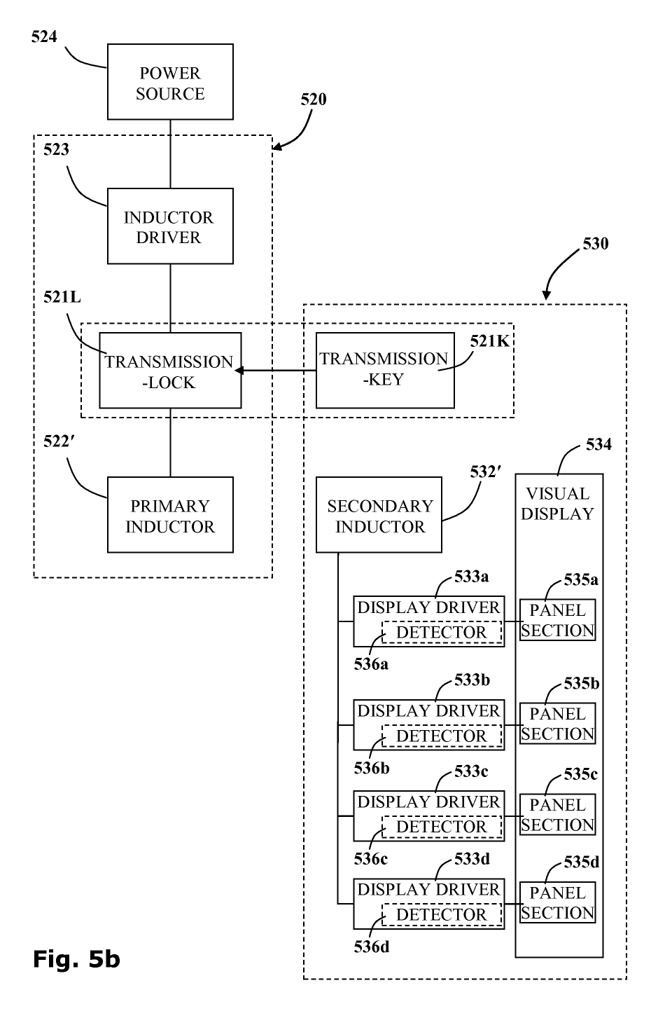

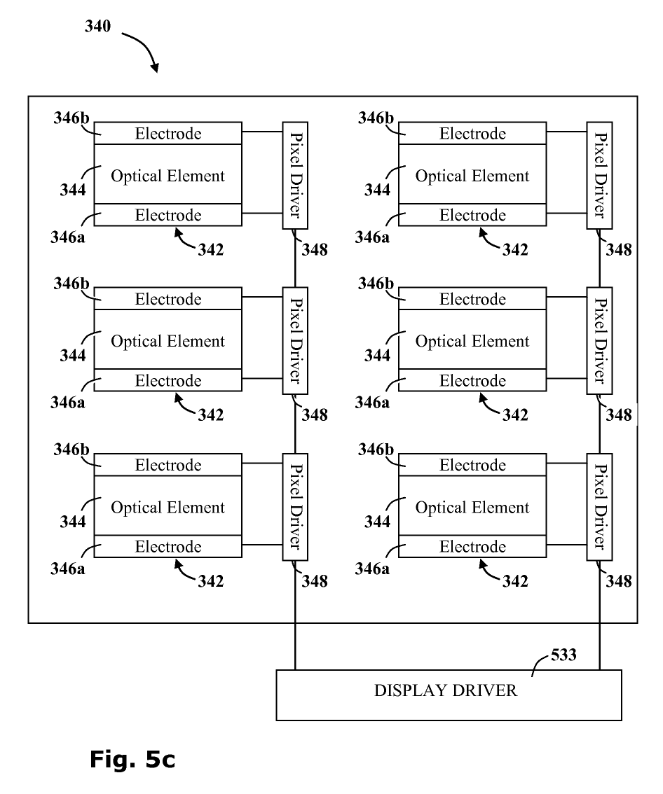

As noted above in relation to FIG. 2a, the power distribution system is particularly suited to modular display systems. Reference is now made to FIG. 5a showing a schematic exploded view of another embodiment of a modular display system 510 for generating an adjustable presentation upon a surface 512 according to one embodiment of the present invention. The surface 512 is constructed from an array of display panels 530 and blank panels 540 mounted upon a support structure 520.

According to various embodiments of the invention, the system 510 may be used to provide, inter alia, adjustable decors for a room, interactive signs, electronic advertising billboards, stage scenery and the like.

The support structure 520, such as a wall or a floor of a room for example, contains a power providing infrastructure including inductive power outlets 522 connected to a power source via driving units 523. Optionally, more than one inductive power outlets 522 are connected to common driving unit 523. In a particular embodiment, suitable wire 525 is used to supply power to the driving unit, for providing a universal A.C. voltage between 90V and 240V, whereas 3 A conductors 527 may be suitable for distributing power to the power outlets 522. In other embodiments alternative conductors may be selected as appropriate.

In order to protect high voltage wires from environmental contaminants such as humidity, dust, salt and the like, in preferred embodiments, the power providing infrastructure is sealed from the environment. Other configurations of driving units 523 and power outlets 522, which may further optimize the power providing infrastructure for power distribution, heat dispersion and the like will occur to the skilled electrical engineer.

Each display panel 530 includes a casing 531 containing an inductive power receiver 532, an array of display drivers 533 and an adjustable visual display 534. The appearance of the adjustable visual display 534 is configured to change when a driving signal is received from a display driver 533. In preferred embodiments each display driver 533 is configured to drive a separate section 535 of the visual display 534. The casing 531 is adapted to be connected to the support structure 520 by some fastening means such as hooks, screws, pins, adhesives, magnets or the like.

It is particularly noted that in embodiments of the invention, power is provided to the display panel via electromagnetic induction therefore there is no need for a conductive connection between the panel and the support structure. Optionally the casing 531 is sealed to protect the internal components from the environment. It will be appreciated that sealed casings 531 represent a particular advantage when the panels are exposed to the open air for example when mounted on a billboard, on the external surfaces of a building or the like.

The blank panels 540, which may have the same size and shape as display panels 530 are optionally used to complete a surface 512 where it is unnecessary to fully cover the support structure with display panels.

The main elements of the display system 510 are presented in the form of a block diagram in FIG. 5b. The support structure 520 is wired to a power source 524 and includes a primary inductor 522′, which draws power from the power source 524 via an inductive driver 523. The primary inductor 522′, such as an inductive coil or the like, is provided to inductively couple with a secondary inductor 532′ incorporated in the display panel 530. The inductive driver 523 provides the electronics necessary to drive the primary inductor 522′. Driving electronics may include a switching unit providing a high frequency oscillating voltage supply, for example. Where the support structure 520 includes more than one primary inductor 522′, the driver 523 may additionally consist of a selector for selecting which primary inductor 522′ is to be driven.

The display panel 530 includes a secondary inductor 532′ configured to inductively couple with the primary inductor 522′ and to provide power to an array of display drivers 533. Each display driver 533 is configured to provide a driving signal to control the visual appearance of a section 535 of the visual display 534. Optionally, the display drivers 533 further include detectors 536 for receiving remote input determining the desired appearance of the associated section 535 of the visual display 534.

In preferred embodiments a transmission-guard 521 is provided to prevent the primary inductor 522′ from being activated when no display panel 530 is present. Such a transmission-guard 521 may consist of a transmission-lock 521L and a transmission-key 521K. The transmission-lock 521L is incorporated into the support structure 520 and connected in series between the power source 524 and the primary inductor 522′. The transmission-key 521K is incorporated into the display panel 530 and unlocks the primary inductor 522′ when it is aligned with the secondary inductor 532′.

Preferably, the transmission-lock 521L comprises at least one magnetic switch and the transmission-key 521K comprises at least one magnetic element. In certain embodiments the magnetic element comprises a ferrite flux guidance core. Optionally, the transmission-lock 521L comprises an array of magnetic switches configured to connect the primary coil to the power source only when activated by a matching configuration of magnetic elements. Typically, the magnetic switch comprises a magnetic sensor, such as a reed switch or Hall switch for example.

In other embodiments, the transmission-guard comprises: an emitter for emitting a release-signal and a detector for detecting the release signal; the transmission-key 521K comprises at least one bridge for bridging between the emitter and the detector, such that when the secondary coil is brought into alignment with the primary coil the release signal is guided from the emitter to the detector. Optionally, the release-signal is an optical signal and the bridge comprises at least one optical wave-guide. Alternatively, the release-signal is a magnetic signal and the bridge comprises a magnetic flux guide. Alternatively, again, the release-signal is selected from the group comprising: mechanical signals, audio signals, ultra-sonic signals and microwaves.

It is noted that in preferred embodiments of the invention the display panels 530 may be readily interchangeable such that a faulty panel may be easily replaced. It will be appreciated that in such an embodiment, for a multi-panel image to be retained where panels have been interchanged some system must be provided to match each panel with its location. To this end it may be advantageous to provide a communication channel between the inductive outlet 520 and the inductive receiver 530 for communicating to each panel, its location upon the support structure. According to one embodiment a signal transfer system is provided for transferring data signals between the inductive power outlets and the inductive power receivers, which typically includes a signal generator for generating a data signal; a transmitter for transmitting the data signal, and a detector for detecting the data signal.

Reference is now made to the block diagram of FIG. 5c, representing an exemplary embodiment of the visual display 340 for use in a display panel 530 (FIG. 5a). The visual display 340 typically consists of an array of pixels 342. In preferred embodiments, after switching the states thereof, the pixels 342 are configured to retain their states and thus their appearance, even when no power is applied. Each pixel 342 includes an optical element 344 sandwiched between two electrodes 346a, 346b wired to a pixel driver 348. The pixel drivers 348 are in communication with the display driver 533 which is configured to provide them with a driving signal as required.

The optical element 344 includes an optically active material, such as a liquid crystal, capable of assuming two or more physical states, the optical characteristics thereof, depending upon its state. The pixel driver 348 is configured to provide a switching voltage across the electrodes 346 such that when the switching voltage exceeds a predetermined threshold, the optical state of the optical element changes from a first optical state to a second optical state. For example, a switching voltage may cause a polarization effect, absorbing some of the light passing through liquid crystals such that the intensity of the light beam therethrough varies with the voltage.

According to some embodiments, the optical element may be a monostable material which is actively held in its second optical state for as long as the switching voltage is maintained above the threshold. A number of monostable display technologies are known in the art and include, for example scattering devices, twisted nematic devices (TN), super-twisted nematic devices (STN), vertically aligned nematic devices (VAN), in-plane switching (IPS), electrically controlled surfaces (ECS) and the like.

In preferred embodiments, the optical element is selected to be a bistable material in which the first optical state and the second optical state are both stable. In some bistable devices, the switching voltage switches the optical element from the first stable optical state to the second stable optical state and when the switching voltage is removed the second optical state is maintained. Indeed, where appropriate, it may be useful for the display to be configured such that once the optical state has been changed, the display disconnects autonomously. A number of bistable display technologies are known in the art and include, for example ferroelectric liquid crystal devices (FLC), BiNem devices, zenithally bistable devices (ZBD), post-aligned bistable displays (PABN), cholesteric liquid crystal devices (CLCD) and the like.

It is noted that any common pixel driving method as known may be used in conjunction with embodiments of the present invention. For example, in the segment driving method, shaped electrode segments may be are wired to dedicated pixel drivers and may be used to construct numbers, letters, icons and the like.

Alternatively, the matrix driving method constructs characters and images from a matrix of pixel dots, i.e. a pixilated array. The pixels of the matrix may be driven directly using dedicated pixel drivers in a manner similar to the segments of the segment driving method. However, if there are n rows and m columns, a direct driving method needs connections, and as the number of pixels is increased, the wiring of dedicated drivers becomes very complex. Thus the so called multiplex driving method may be preferred wherein the pixels are arranged at the intersections of vertical signal (“column”) electrodes and horizontal (“row”) scanning electrodes. Thus all the pixels across each row are connected together on one substrate and all the pixels in each column are connected on the opposite substrate. To switch a pixel, a voltage (+V) is applied to the row including that pixel, and then an opposite voltage (−V) is applied to the column including that pixel, with no voltage being applied to the columns which do not need to be switched. In consequence of this configuration, instead of requiring connections, the multiplex method only requires connections.

It will be appreciated that in applications where the electrodes and connecting wires would otherwise obscure the viewers line of sight to the optical element, it is advantageous to use electrodes constructed from a transparent conductive material such as indium tin oxide (ITO) for example.

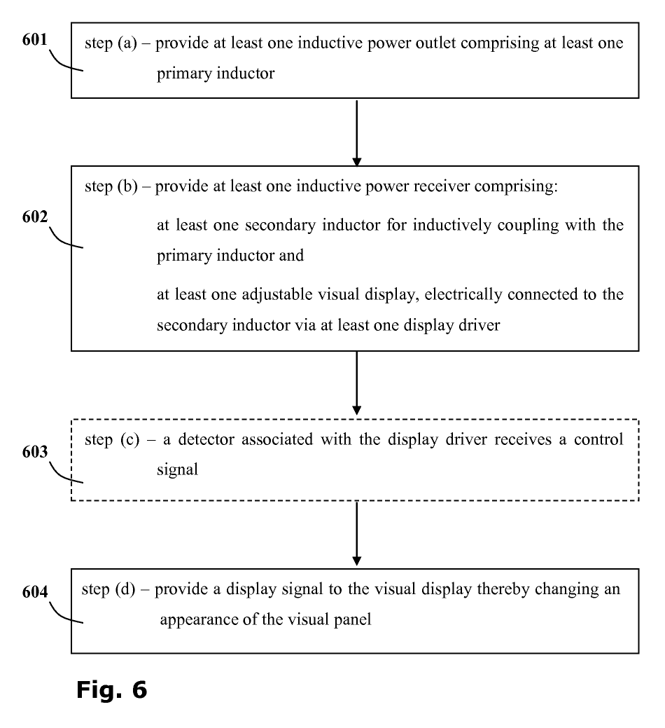

FIG. 6 is a flowchart representing a method for providing an adjustable visual display according to still another embodiment of the invention. The method comprises the following steps:

(a)—providing at least one inductive power outlet comprising at least one primary inductor 601;

(b)—providing at least one inductive power receiver comprising: at least one secondary inductor for inductively coupling with the primary inductor; and at least one adjustable visual display, electrically connected to the secondary inductor via at least one display driver 602;

(optional) (c)—a detector receiving the control signal 603, and

(d)—providing a display signal to the visual display thereby changing an appearance of the visual panel 604.

### Remote Controlled Displays

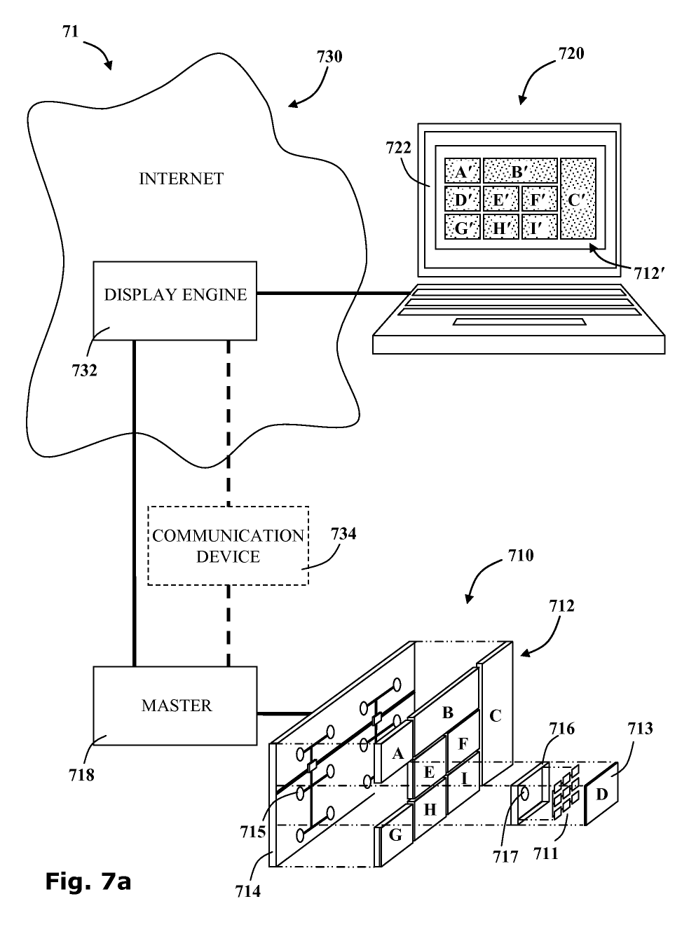

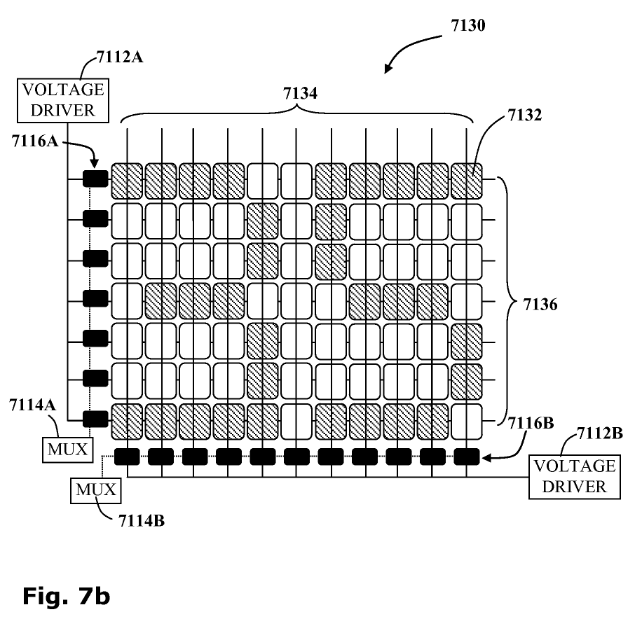

Reference is made to FIG. 7a which schematically shows the main components of a system 71 for remotely controlling a modular display 710. The system 71 includes a computer terminal 720 connected to the internet 730 and a modular display 710 in communication with a display engine website 732.

The modular display 710 includes an array of display panels 712A-I which are mountable on to a support structure 714, such as a wall, or a floor of a room, for example. The display panels 712 may have various shapes and sizes. Optionally, similarly sized panels are configured to be interchangeable. Using panels in combination, an extended image spanning multiple display panels 712 may be presented. The modular display 710 is useful for providing, inter alia, adjustable decors for a room, interactive signs, electronic advertising billboards, stage scenery and the like.

The panels 714 include an array of display drivers 711 and an adjustable visual display 713. The display drivers 711 are configured to send a driving signal to the visual display 713. The visual display 713 is adapted such that its visual appearance is altered in response to the driving signal. In preferred embodiments each display driver 711 is configured to drive a separate section of the visual display 713.

Each panel may be enclosed in a casing 716 which is adapted to be connected to the support structure 714 by some fastening means such as hooks, screws, pins, adhesives, magnets or the like. In preferred embodiments, the casing 716 further contains an inductive power receiver 717, adapted to inductively couple with an inductive power outlet 715 mounted upon the support structure 714. Accordingly, the support structure 714 may incorporate an array of inductive power outlets 715 connected to a power supply via driving units 719. Optionally, more than one inductive power outlet 715 is connected to a common driving unit 719. Where power is provided to the display panel via electromagnetic induction, there is no need for a conductive connection between a panel 712 and the support structure 714. Consequently, the casing 716 may be sealed to protect the internal components of the display panel from the environment. It will be appreciated that sealed casings 716 represent a particular advantage when the panels are exposed to the open air for example when mounted on a billboard, on the external surfaces of a building or the like.

The computer terminal 720 may be connected to the internet 730 and may provide a user interface for controlling the visual output of the modular display 710. In preferred embodiments, the user interface includes a visual representation 712′ of the modular display 710, which is presented on the screen 722 of the computer 720. The visual representation 712′ is divided into virtual panels A′-I′ which correspond to similarly shaped display panels A-I of the modular display 710. The user interface typically provides further means by which a user may select an image for displaying on an individual panel 712 or over the whole or part of the modular display 710. In some embodiments, the user interface may be a computer operable code stored upon the computer 720 as a plug-in application executable from a browser, an add-on application executable directly by the computer or the like.

The display engine 732, which is usually hosted on a website, is adapted to receive remote signals from the user interface running on the computer terminal 720. The display engine 732 is operable to resize the user selected image, to adjust its pixel resolution or otherwise to optimize the image for display upon the modular display 710. The optimized visual configuration is communicated to a display master 718 controlling the modular display 710. The communication channel from the display engine 732 to the modular display 710 may be via a direct cable connection, alternatively, an indirect communication channel may be provided via a communication device 734 such as a 3G telephone, for example.

Referring now to FIG. 7a, a dot matrix 7130 is shown which may be used to construct characters and images in the visual display 713 (FIG. 7a) according to certain embodiments of the invention. The pixels 7132 of the matrix may be driven directly using dedicated drivers (in a manner known as segment driving method). However, if there are n rows and m columns, a direct driving method needs connections, and as the number of pixels is increased, the wiring of dedicated drivers becomes very complex.

Alternatively, the so called multiplex driving method may be used. The pixels are arranged at the intersections of vertical signal electrodes (or column electrodes) 7134 and horizontal scanning electrodes (or row electrodes) 7136. Thus all the pixels across each row are connected together on one substrate and all the pixels in each column are connected on the opposite substrate. To switch a pixel, a voltage (+V) is applied to the row including that pixel, and then an opposite voltage (−V) is applied to the column including that pixel, with no voltage being applied to the columns which do not need to be switched. Thus instead of requiring connections, a multiplex method only requires connections. Typically, a separate voltage driver is connected to each of these connections, thereby requiring a total of voltage drivers.

It is feature of certain embodiments of the current invention, that a common voltage driver 7112A, 7112B is connected to multiple electrodes via individual switches 7116A, 7116B which are controlled by a MUX module 7114A, 7114B. Optionally, a first dedicated voltage driver 7112A provides voltage to the column electrodes and a second voltage driver 7112B provides voltage to the row electrodes, each with a separate MUX module 7114A, 7114B. Alternatively, a single voltage driver (not shown) may control all the connections. Still other configurations may be used to suit requirements.

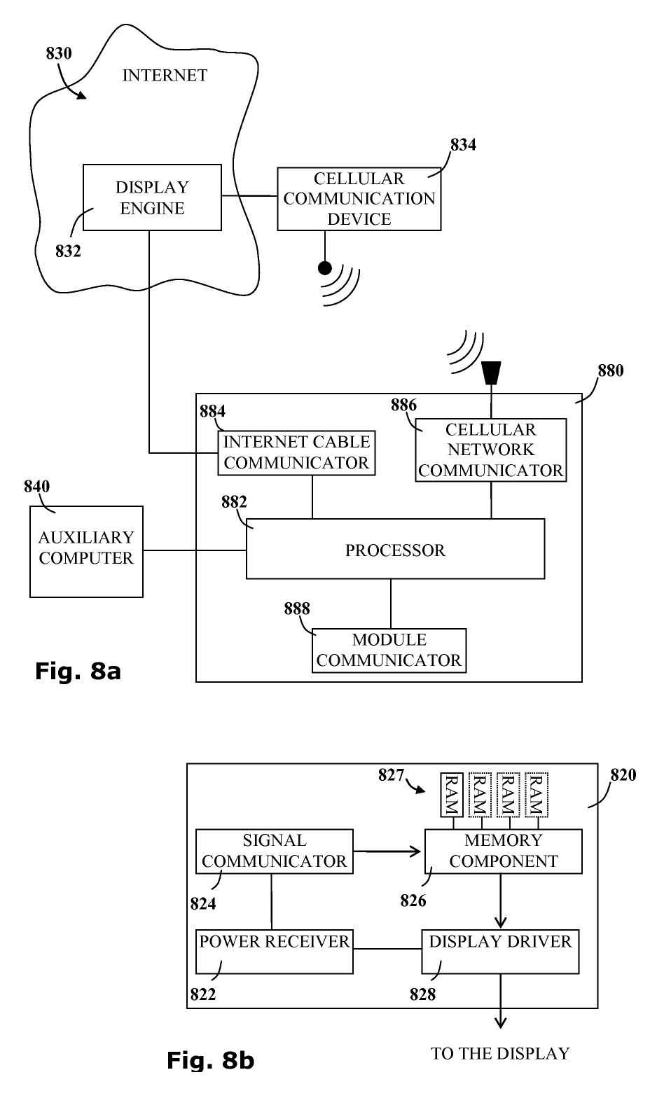

Referring now to FIG. 8a, a block diagram is shown representing the main components of a display master 880 for use in various embodiments of the invention. The display master 880 includes a processor 882, an internet cable communicator 884, a cellular network communicator 886 and a module communicator 888.

The display master 880 receives image data from the display engine website 832. Image data may be received via a cable connected to the internet cable communicator 884 or via a communication device 834 connected to the cellular network communicator 886. The processor 882 is configured and operable to distribute display data to the display panels 712 (FIG. 7a) via the module communicator 888 such that each display panel A-I receives image data related to the section of the image appearing on the corresponding virtual panel A′-I′ of the visual representation 712′ (FIG. 7a). Optionally, the display master 880 may be connected directly to an auxiliary computer 840 for maintenance or for initiation of the modular display 810 (FIG. 7a), for example.

Referring now to FIG. 8b, a block diagram of the main components of a display module 820 for use in embodiments of the invention is shown. In an exemplary embodiment, the display module 820 includes a power receiver 822, a signal communicator 824, a memory 826, a display driver 828 and a display screen 829.

The power receiver 822, which according to preferred embodiments includes a secondary inductor for receiving power from the support structure via induction, provides power for operating the display module as necessary.

The signal communicator 824 is configured to receive display data from the module communicator 888 (FIG. 8a) of the display master 880 and to transmit feedback data to the master 880.

The memory component 826 may store received data for sending to the display driver 828. Optionally, the memory component 826 may store a plurality of data files for selectively displaying various images on the display panel.

According to one configuration, the memory component 826 comprises a plurality of external dual-port RAMs 827. Optionally, RAMs may communicate with the signal communicator 822 via a bus and the signal communicator 822 is configured to read and write data to the memory 826. Preferably, the memory is adjustable such that a user may add or remove RAM units from the bus as required. The bus may further connect with the display driver 828.

In preferred embodiments, the display module 820 is labeled by a unique identifier and the identity of the display module 820 is communicated to the display master 880. The unique identifier may, for example be a serial number in some readable form such as a bar code or the like. Alternatively, the unique identifier may be a digital code stored in the memory component 826 which may be transmitted via the communicator 824.

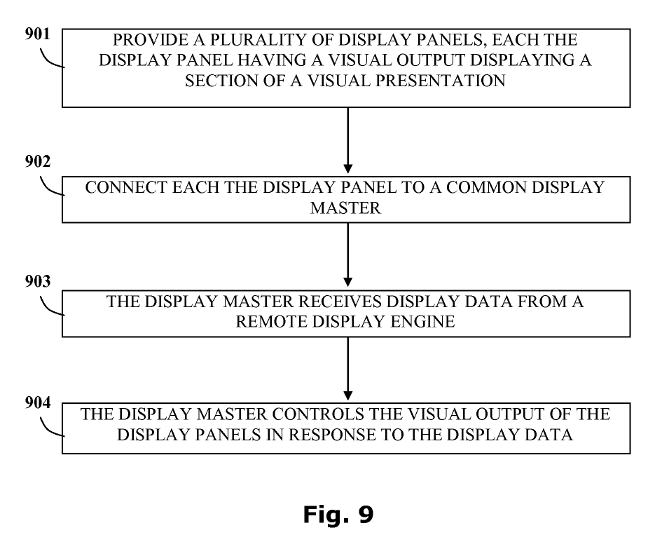

Reference is now made to FIG. 9 which shows a flowchart of a method for remotely controlling a display system according to an exemplary embodiment of the invention. The method includes the following steps: providing a plurality of display panels, each such display panel having a visual output displaying a section of a visual presentation 901; connecting each display panel to a common display master 902; the display master receives display data from a remote display engine 903, and the display master controls the visual output of the display panels in response to the display data 904. It is noted that this method may extend the method described hereinabove in relation to FIG. 6. In particular, it will be appreciated that the steps of the display master receiving data 903, and controlling the visual output 904 may be considered substeps to step (d) of providing a display system 604 in the method of FIG. 6.

According to various embodiments of the invention, the modular display is operated as follows: A user attaches a display panel module to a support structure, for example by hanging it onto a wall. The modules are configured to automatically switch on and connect with the display master which may be connected to an auxiliary computer for initiation. The newly installed module is registered, and its size, shape and position are recorded. As further modules are attached and registered, a complete pattern of the display may be constructed on the auxiliary computer. The newly installed display structure is registered on the display engine website by uploading the pattern of the display structure alongside an identification code of the display master, such as a Mac address, IP address or domain name thereof. Once registered, the visual output of the display may be controlled remotely by computer terminals connected to the display engine website.

The system may be operable in a number of different modes such as an installation mode, an operational modes and a maintenance mode, as described hereinbelow.

### Installation Mode

During installation of a new display configuration, a master may be connected to an auxiliary computer. As each display panel module is attached to the support structure, the module sends data relating to its size, shape and position to the master. The master is configured to relay this information to the auxiliary computer. These steps are repeated for all modules making up the display. Then the computer stores the modular pattern of the display including the shapes, sizes, locations and orientations of all the modules thereof. The modular display may be registered by uploading data relating to the modular pattern of the display to the display engine website, together with an identification code and an internet address for the master. Optionally, when the display is registered with the display engine, a Mac address is recorded in order to match the master to its corresponding display. It will be noted that the master of a display may be switched by changing the Mac address registered with the display engine.

It is noted that more than one modular display may be initiated simultaneously. It is therefore necessary that each module is matched to the correct master. In some embodiments this is achievable by printing a unique bar code for each module which may be read by the master before switching on the module so that the master will be the one that searches for the module.

It is further noted that a display should be accessible only by authorized users. This may be achieved, for example, by protecting access thereto with a password and a secure connection, such as SSL, TLS or the like. When connecting a module, the display may be further protected by requiring the matching of each module serial number to a password.

The communication between the master and the modules may be wireless whereas the connection and between the master and the auxiliary computer is generally via a connecting cable. The display engine may communicate with the master via a cellular communication device, such as a 3G network device or the like, which may be incorporated into the system. An additional communication channel may use a wired internet connection.

In some embodiments a visual feedback from the display to the display engine may be accessed via a remote controller. For example cameras directed towards the visual output of the display may be provided, the output thereof being relayed to the display engine.

### Operational Mode

In operational mode a user may remotely control the modular sign from a computer terminal connected to the internet via the display engine. Typically, the user connects to the display engine website via a web browser. Alternatively a stand alone application may be executable on the user's communication device.

The user is preferably presented with a virtual representation of the modular pattern of the display. The visual output of the panel may be altered by selecting a desired image and arranging this image onto the modular pattern. The desired configuration is then uploaded to the display engine. The display engine is configured to process the image to suit the resolution of the display. For example 3 bytes of digital data may be matched to each pixel using a dynamic table. Furthermore, the display data may be separated into sub-units for distribution to individual display modules and sent to the master according to a site-master protocol. The user may have the option to send more then one image to the sign. When the display master receives display data, each sub-unit of data is sent to the corresponding display panel according to a master-module protocol. The display panel may be configured to save the data to a memory and when the data transmission finishes, may interrupt a MCU in the display driver. The display engine may also shut down a specific module, group of modules or even the complete display.

In some embodiments, a user may request feedback from the display. It is noted that website responses to such requests should have a frequency no higher than the frequency with which the display data is sent. In a first feedback configuration, automatic feedback is sent after each package of display data. The display master may broadcast a feedback request to the display modules. The modules receive the request, interrupt the MCU in the display driver and wait for a response. The display systems' MCU then interrupts the operation system in the module and responds to the request. Data may be transferred from the display driver to the operation system according to the site-master protocol and the module may send a response to the master to be relayed to the display engine site.

According to a second feedback configuration, feedback is initiated by a display module. The display driver's MCU interrupts the operation system in the module and sends feedback. Data is then transferred from the display driver to the operation system, and the module sends data to the master which is relayed to the display engine site. In still a third feedback configuration, feedback is initiated by the user. The user requests appropriate feedback via the website and may decide whether to send the request to a specific module or to broadcast it to all the modules.

In a particular embodiment, the feedback signal is 32 bytes long and contains data relating, for example, to a failure notification, such as the kind of failure and the temperature of the module. The master may send feedback data containing a serial number of a module in case that module fails to response to the feedback request. The user may further change the number and the position of the modules at any time, and update such changes via the web site.

Typically, the display master is not connected to the auxiliary computer during operational mode. It is noted that the display engine is preferably compatible with receiving uploaded images from other communication devices such as a mobile telephone for example.

### Maintenance Mode

In maintenance mode, a user has the option to bypass the display engine and control the display master directly using the auxiliary computer. The auxiliary computer may execute a stand-alone application having functionality similar to that of the display driver as well as that used during installation. For example the auxiliary computer may allow a user to operate the display master functions of installing and uninstalling modules, requesting feedback, sending control commands, sending images and the like.

Thus the various embodiments described hereinabove provide a power distribution system for controlling power to a plurality of outlets. The system is particularly useful for controlling interchangeable electrical devices and modular display units. The various embodiments are provided to illustrate the invention however, the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A remotely controlled modular display comprising:
a plurality of display panels, each said display panel having a visual output displaying a section of a visual presentation; and
a display master for receiving display data from a remote display engine and for controlling the visual output of said display panels;
wherein said display engine is controlled by at least one computer terminal comprising a storage medium storing computer readable code operable to provide a user interface for controlling said visual output.

2. The remotely controlled modular display of claim 1 wherein said user interface comprises a visual representation of said display panels.

3. The remotely controlled modular display of claim 1 wherein said user interface comprises means for selecting an image to be displayed upon said display panels.

4. The remotely controlled modular display of claim 3 wherein said display engine is operable to adjust display parameters of said image.

5. The remotely controlled modular display of claim 4 wherein said display parameters are selected from the group consisting of: size, resolution and file type.

6. The remotely controlled modular display of claim 1 wherein said display modules are mountable to a support structure.

7. The remotely controlled modular display of claim 1 wherein said display module comprises a power receiver wired to a display driver, operable to provide a driving signal for adjusting said visual output.

8. The remotely controlled modular display of claim 7 wherein said power receiver comprises an inductive power receiver for inductively coupling with an inductive power outlet wired to a power supply.

9. The remotely controlled modular display of claim 1 wherein at least one said display panel comprises:
at least one inductive power receiver comprising a secondary inductor for inductively coupling with a primary inductor of an inductive power outlet connected to a power source; and
at least one adjustable visual display, electrically connected to said secondary inductor via at least one display driver, wherein the display driver provides a display signal for changing appearance of said visual panel.

10. The remotely controlled modular display of claim 9 wherein at least one said display panel comprises a transmission-guard for preventing said primary inductor from transmitting power in the absence of said adjustable panel.]

11. The remotely controlled modular display of claim 9 wherein said inductive power receiver and said visual display are contained within a sealed casing.

12. The remotely controlled modular display of claim 9 wherein the appearance of said visual display is maintained after said primary inductor stops transmitting power.

13. The remotely controlled modular display of claim 12 wherein: said visual display comprises an array of pixels, each of said pixels comprise at least one optical element having at least two optical states, said optical element being in conductive contact with at least two electrodes, and said display signal comprises a voltage applied to at least one pair of said electrodes thereby altering said optical element from a first optical state to a second optical state.

14. The remotely controlled modular display of claim 9 wherein said display driver further comprises a signal detector for detecting a control signal from a remote controller.

15. The remotely controlled modular display of claim 1 wherein at least one said display panel comprises a positioning system for communicating coordinates of said panel to said display driver.

16. The remotely controlled modular display of claim 1 wherein at least one said display panel comprises an attachment means for attaching to a surface.]

17. A method for remotely controlling a modular display comprising the steps of: providing a plurality of display panels, each said display panel having a visual output displaying a section of a visual presentation;
connecting each said display panel to a common display master;
providing a user interface for controlling a display engine to control said visual output;
said display master receiving display data from said display engine; and
said display master controlling the visual output of said display panels in response to said display data.

18. The method of claim 17 wherein at least one said display panel comprises an adjustable visual display electrically connected to at least one display driver and the step of said display master controlling the visual output of said display panels in response to said display data comprises providing a display signal to said adjustable visual display associated.

19. The method of claim 18 wherein said visual display comprises an array of pixels, said pixels comprise at least one optical element having at least two optical states, said optical element being in conductive contact with at least two electrodes, wherein the step of providing a display signal to said visual display comprises said display driver applying a voltage to at least one pair of said electrodes thereby altering said optical element from a first optical state to a second optical state

20. The method of claim 17 wherein said digital master comprises at least one inductive power outlet comprising at least one primary inductor; and said display panel comprises at least one secondary inductor for inductively coupling with said primary inductor.
